(19) United States
(12) Patent Application Publication
(10) Pub. No.: US 2006/0152686 A1
(43) Pub. Date: Jul. 13, 2006

(54) Short arc lamp light engine for video projection

(76) Inventors: Serdar Yeralan, Pleasanton, CA (US); Rudi Blondia, Fremont, CA (US)

Correspondence Address: STALLMAN & POLLOCK LLP, 353 SACRAMENTO STREET, SUITE 2200, SAN FRANCISCO, CA, 94111, US

(21) Appl. No.: 11/290,980

(22) Filed: Nov. 30, 2005

Related U.S. Application Data
(60) Provisional application No. 60/634,729, filed on Dec. 9, 2004.
(60) Provisional application No. 60/634,561, filed on Dec. 9, 2004.

(51) Int. Cl. G03B 21/14

(52) U.S. Cl. 353/84

(57) ABSTRACT

A video projection system can utilize an advanced xenon short arc lamp to obtain a bright, high-resolution color image using a sufficiently cost-effective, compact, and lightweight design. An unwanted radiation component of a white light beam produced by the xenon lamp, such as an infrared and/or ultraviolet component, can be removed using any of a number of approaches, such as using a dichroic coating on the input end of an integrator rod or the exterior circumference of a light tunnel. Alternatively, a beam separating mirror can be used to remove the unwanted component. An advanced color wheel also can be used which has high transmittance over the unwanted spectrum and high reflectance over the visible spectrum, in order to transmit the unwanted radiation out of the beam path of the projection system.

### CLAIM OF PRIORITY

This application claims priority to U.S. Provisional Patent Application No. 60/634,729, filed Dec. 9, 2004, which is hereby incorporated herein by reference.

### TECHNICAL FIELD OF THE INVENTION

The present invention relates generally to projection systems and particularly to color sequential micro-display projection systems.

### BACKGROUND

As the demands on video technology continue to increase, it is becoming ever more important to provide a video display mechanism that provides a high quality image at a reasonable price. Further, it is desirable that this display mechanism be as compact and lightweight as possible. While a substantial amount of effort has been put into developing video projection systems that produce high-quality color images, it has proven difficult to obtain an acceptable projected image when using a compact video projection system in a well-lighted area. In order to obtain a reasonable image, existing projection systems have a large number of optical elements requiring sufficient spacing between the elements, resulting in bulky, awkward, and/or heavy devices.

In an effort to improve quality and design, many existing video projection systems have moved to a display technology such as Digital Light Processing™ (DLP), originally developed and trademarked by Texas Instruments of Dallas, Tex. An example of such a system 100 is shown in the example of FIG. 1. In this system, a white light source 102 is used to project a beam of light 104 through a series of optical elements (some of which are not shown in FIG. 1 but are known to one of ordinary skill in the art) and onto at least one electronic chip 108, typically referred to as a digital micromirror device (DMD) or deformable mirror device. A standard DMD 108 contains a large array of micromirrors 110 capable of alternating between one of two tilt directions in response to an electric signal. These tilt directions can be designated as the “on” position and the “off” position. Each mirror can cycle between the “on” and “off” positions at a rate on the order of thousands of times per second, with each micromirror representing one spot, or pixel, of the final projected image. The final image typically is made up of a rectangular array of these pixels. When one of the micromirrors is in a first tilt direction, or the “on” position, light of a certain color (determined by the synchronized color wheel or filter(s) in the system) that is incident upon that micromirror will be directed (see ray 112) toward an imaging element 116 such as a projection lens or screen. When a mirror is in a second tilt direction, or the “off” position, the incident light will be directed away from the imaging element (see ray 114), such as to a light trap 118 capable of absorbing or otherwise preventing the reflected light from reaching the imaging element. Each micromirror can be used to direct light onto the imaging element 116 at high frequencies, such as for hundreds or thousands of cycles for each frame of video. Such rapid cycling of the micromirrors cannot be detected by the human eye, but instead can be used to determine the color that is displayed for each mirror, and how brightly that color is displayed. The less amount of time a color is displayed for a given pixel, the less the eye is able to pick up that color, resulting in a darker shade. For instance, a pixel that is to be substantially bright can undergo more cycles pointed toward the imaging element than a pixel that is to be less bright, in order to direct more light to the imaging element. Existing DMDs contain over one million micromirrors, and in order to meet the HDTV standard can include at least two million micromirrors.

In addition to determining the brightness for each pixel by controlling the cycling of each mirror, it can be necessary to select the appropriate color for that pixel in the projected image. When only one DMD chip 108 is used, a color wheel 106 typically is used to allow for field sequential color. The color wheel 106 typically includes areas of the three primary color filters (red, blue, and green), which when rotated in the path of the beam 104 from the white light source provide periods in which light to be reflected by each micromirror 110 will pass through one of those primary colors. It then is possible to synchronize the tilting of each micromirror to only reflect light to the imaging element when the beam passes through the appropriate color. A system display controller 120 can be used to control how many cycles of each primary color are displayed for each pixel, as not every pixel is intended to correspond exactly to one of the primary colors. If a pixel is to display yellow, for example, the system controller 120 might direct half of the “on” cycles to occur during a red filter region of the rotating color wheel 106, while the other half of the “on” cycles are directed to occur during a green filter region, with no “on” cycles during the blue filter region. Using the appropriate combinations can allow a DMD to display up to 16.7 million colors in one embodiment, as well as 256 different shades of gray. Shades of gray can be obtained by splitting the cycles evenly among all three primary colors, with the brightness of the shade determined by the number of cycles. In other embodiments, the system might include one DMD for each primary color, whereby a color wheel need not be used and the amount of each color projected to a pixel is determined by synchronizing the three DMDs, each behind a filter of the appropriate primary color.

When selecting a source of white light to be used with the projection system, it can be desirable to select a source that demonstrates sufficient brightness and stability. A high power arc lamp, such as a 270 Watt high pressure mercury arc lamp, typically is used to produce a high intensity illumination beam that meets lumen specifications. The small arc gap of a mercury arc lamp impacts the optical alignment of the projection system, increasing the importance of lamp stability. In existing arc lamps it can be difficult to achieve the precision alignment needed for the arc gap dimensions to assure consistent lamp operation. Further, these mercury lamps provide only a reasonably acceptable lifetime. Existing arc lamps also include a relatively large number of parts, which increases the cost of each lamp.

### BRIEF DESCRIPTION OF THE DRAWINGS

FIG. 1 is a diagram of a video projection system of the prior art.

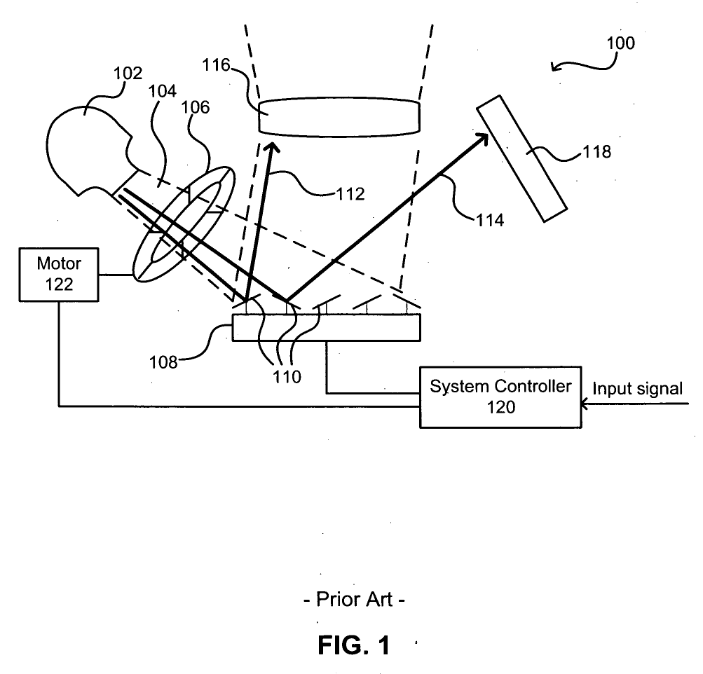

FIG. 2 is a diagram of a first video projection system in accordance with one embodiment of the present invention.

FIG. 3 is a diagram of a second video projection system in accordance with one embodiment of the present invention.

FIG. 4 is a diagram of a third video projection system in accordance with one embodiment of the present invention.

FIG. 5 is a diagram of a fourth video projection system in accordance with one embodiment of the present invention.

### DETAILED DESCRIPTION

Systems and methods in accordance with various embodiments of the present invention can overcome these and other problems with existing projection systems, such as those based on microdisplay technologies using a DMD as described above. In various embodiments, an advanced xenon short arc lamp can be used as the white light source, to provide an extremely bright light while providing for a longer lifetime. An example of such an advanced xenon arc lamp is provided in U.S. Provisional Patent Application No. 60/634,561, filed Dec. 9, 2004, entitled “METAL BODY ARC LAMP,” which is hereby incorporated herein by reference. While various embodiments will be described herein with respect to such advanced xenon arc lamps, it should be understood that other arc lamps are known that also could be used with embodiments of the present invention, such as are disclosed in U.S. Pat. Nos. 5,721,465; 6,114,807; 6,181,053; 6,316,867; and 6,561,675, each of which is hereby incorporated herein by reference. In particular, any projection-appropriate lamp that generates radiation in a wavelength range outside the visible range, which would be unwanted for various systems and applications, can take advantage of approaches in accordance with various embodiments described herein. For the purposes of simplicity, this unwanted wavelength range is described herein as the infrared (IR) wavelength range, which is commonly emitted by xenon arc lamps. It should be understood, however, that this unwanted range could include other wavelength range(s) for any of a number of different lamps and/or applications, as would be understood to one of ordinary skill in the art.

The xenon spectrum is broad and flat compared to other existing lamps, producing light that is more similar to the daylight spectrum. Such a spectrum can produce substantially clear images, which typically is beneficial for video applications. These xenon arc lamps also contain fewer parts and are easier to assemble, thereby reducing the cost of the lamps. When using a xenon arc lamp, however, the full spectrum of the lamp can extend outside the visible spectrum, such as into the infrared (IR) spectrum as well as the ultraviolet (UV) spectrum. Simply substituting a xenon arc lamp into an existing system would produce an undesirable amount of heat and intensity from the infrared spectrum, for example, which could reduce the lifetime of the system optics while providing no advantage in the visible portion of the spectrum. It therefore can be necessary to develop systems that can take advantage of these improved xenon lamps while eliminating the problems associated with the infrared radiation produced by these lamps.

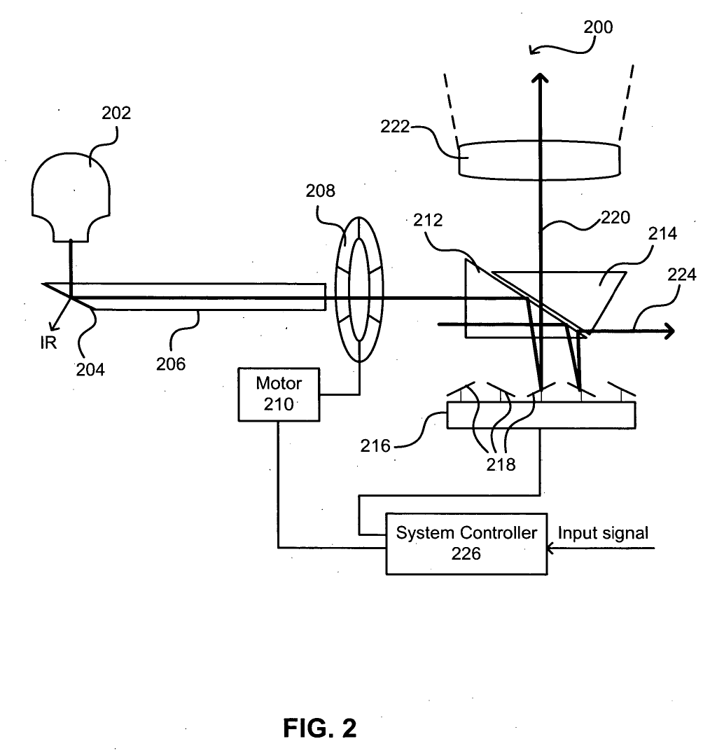

FIG. 2 shows a projection system 200 in accordance with one embodiment of the present invention. In this system, a xenon short arc lamp 202 produces a beam of white light. The arc lamp can be placed in a vertical orientation, with the transmittance window being positioned at the bottom of the lamp. This alignment allows heat to rise to the reflector region of the lamp, where the heat can most easily be removed through the lamp body. A heat sink (not shown) can be positioned in the projector apparatus at the back of the lamp in order to facilitate heat removal. This alignment also allows any tungsten sputtered from the electrodes during operation to deposit at the back of the reflector, where the deposit does not substantially affect the light efficiency of the lamp. Furthermore, such alignment provides for symmetric heat loading and arc positioning, resulting in improved degradation characteristics with improved stability and lifetime.

The beam of white light from the source can be incident upon the input end of a light pipe, such as a hollow light tunnel or a solid integrator rod 206 as shown in this embodiment. The input end of this rod is angled with respect to the beam, such that the visible portion of the beam can be reflected into the integrator rod 206. The input end of the integrator rod has disposed thereon a dichroic coating 204, which can be selected to transmit the infrared portion of the beam while reflecting the visible portion. The dichroic coating 204 also can be selected to reflect and/or transmit any ultraviolet portion of the beam. The coating can contain thin layers of dichroic materials such as metallic oxides including titanium, silicon, and/or magnesium. A dichroic coating can serve as a reflector for the beam to direct a visible component of the beam (for example) into the integrator rod, while absorbing and/or transmitting radiation in the infrared and/or ultraviolet bands, whereby an amount of heat and intensity is removed from the beam as the beam is reflected.

The reflected portion of the beam propagates through the integrator rod 206. The integrator rod receives the reflected beam at the input end and creates at the output end a substantially uniform illumination. The integrator rod 206 can be made of any appropriate material, such as a solid glass or fused silica, which allows for total internal reflection of the light therein. This internal reflection allows the light propagating through the integrator rod 206 to be reflected many times therein, whereby the beam is homogenized to have a substantially uniform intensity. The integrator rod 206 also can have an external coating and/or cladding that strengthens the rod without affecting the internal reflection. The integrator rod can be used to shape the beam through internal reflection, allowing the beam to have the same aspect ratio, for example, as the DMD discussed below. The integrator rod can have a substantially consistent cross section along the length of the rod, or can taper from one end to the other. If necessary, at least one lens or optical element can be used to focus the beam on the input end of the integrator rod 206.

Upon exiting the integrator rod 206, the beam can be incident upon a filter region of a rotating color wheel 208. As discussed above, the color wheel can comprise a rotatable disk having at least three filter regions spaced about a circumference of the disk, such that when the color wheel is rotated by a wheel motor 210 the beam will sequentially pass through each filter region. This allows the beam to alternately include any of the three primary colors, and optionally to pass the entire white light through the wheel if there is a clear or non-filter region positioned about the circumference of the wheel. A clear filter region passing white light can be used to increase the intensity of the light passing through to the end projection screen (not shown). The wheel motor 210 can rotate the color wheel at any appropriate speed, such as a rotation speed in the range of about 3,600 to about 10,800 rpm, or about one to three times the refresh rate of a standard video display. Any of the filter regions of the color wheel can include a reflective coating that prevents a part of the spectrum from reaching sensitive components in the optical system, such as an ultraviolet and/or infrared coating. At least one lens or other optical element can be used to focus the beam exiting the integrator rod 206 onto the color wheel 208. Where the integrator rod and color wheel are placed in close proximity, there may be no need for additional optical elements to image and/or focus the beam, thereby reducing the number of necessary components, reducing cost, and facilitating ease of alignment. Further, positioning the color wheel near the end of the integrator rod spreads the light over substantially the entire cross-sectional area of the rod, whereby the optical power per unit area is less than would be experienced if the color wheel were placed near the entrance of the rod (where the light typically is being focused down to a relatively small area). This lower energy density can lessen the amount of color wheel damage.

It should be understood that a number of other optical configurations can be used with various color filtering devices known and/or used in the art. For example, there can be multiple light sources, or a splitting of a light beam from a single source into a plurality of beams, with each beam being passed through a separate color filter. A light pipe can be used for each beam, or for a single beam that is eventually split, with means discussed herein for removing the unwanted radiation and heat from the beam.

After passing through the color wheel in this example, the filtered beam can be incident upon a beam steering element such as a total internal reflection (TIR) prism assembly, which can include a spaced apart first prism 212 and second prism 214. The prisms in the prism assembly can be oriented such that an air space interface between the prisms is close to the critical angle of reflection, whereby the beam undergoes total internal reflection and is directed to the DMD device 216. The TIR angle of the prisms can depend upon the material(s) used, as is known in the art. Materials and angles that can be used in TIR prism assemblies are discussed, for example, in U.S. Pat. No. 6,726,332, issued Apr. 7, 2004, which is hereby incorporated herein by reference. Other interfaces also can be used, such as may include a PBS coating, dichroic coating(s), diffractive surfaces, waveplates, or polarizers, depending on the type of display device being used.

The filtered beam reflected by the prism assembly then can be incident upon a DMD 216, LCD, or other device for selectively and/or directionally reflecting and/or transmitting portions of the filtered beam based on position within the beam. As discussed above, the DMD typically includes a rectangular array of micromirrors 218 that can be switched between an “on” position and an “off” position. When a micromirror 218 is at the “on” position, the portion of the filtered beam that is incident upon that mirror will be reflected at a first angle, referred to herein as a projection angle, as a projection beam portion 220. When a micromirror is at the “off” position, the portion of the filtered beam that is incident upon that mirror will be reflected at a second angle, referred to herein as an absorption angle, as an absorption beam portion 224. As discussed above, each micromirror 218 can correspond to a pixel of the final image, and can be used to direct light along the projection and absorption angles at high frequencies, such as for hundreds or thousands of cycles for each frame of video. A system controller 226 can receive an input signal containing the video information to be displayed, and can send a control signal to the DMD indicating the rapid cycling for each of the micromirrors to determine which color is displayed for each mirror, and how brightly that color is displayed. The cycling of the mirrors can be coordinated by the system controller 226 with the color wheel, as the system controller can send a control signal to the color wheel motor 210, and/or receive a monitor signal from a color wheel sensor (not shown), to determine the location of each filter region relative to the beam passing through the color wheel 208. The tilting of each micromirror then can be synchronized to only reflect light along the projection angle when the appropriate color is incident upon the micromirror, as discussed above. The system controller can include a scaler to scale the resolution of the input video signal, such as through interpolation. Projectors typically have a built-in scaler allowing the display of image sources having resolutions that are different from the native resolution of the projector.

Light reflected from the micromirrors again can be incident upon the interface in the prism assembly between the first prism 212 and second prism 214. Reflected light that is incident upon the interface at the projection angle can pass through the prism assembly as a projection beam portion 220 and can be incident upon a projection lens 222. Reflected light that is incident upon the interface at the absorption angle can be reflected away from the projection lens 222 as an absorption beam portion 224. An absorption element (not shown) can be used to absorb the absorption beam portions exiting the prism assembly in order to prevent the absorption beam portions from affecting the projected image.

The projection beam portions 220 passing through the prism assembly can be incident upon a projection lens 222 or other optical element. A projection lens can be used to focus the projection beam portions on an imaging element or screen (not shown) as a projected image. The projection lens can be selected based on a number of characteristics as known in the art, such as the necessary throw ratio. The throw ratio (D/W) is the distance (D) from the screen that a projector is to be located in order to create a specified size image for an image having a specific width (W). The throw ratio can depend, for example, on whether the projection system is used in a front projection or rear projection system.

In order to improve the performance of the projection system, at least one heat sink (not shown) can be used to remove heat from the lamp assembly. The heat sink can be positioned to accept the metal or ceramic body of the lamp, or a projection portion thereof, in order to transfer heat from the lamp body. Including the heat sink as part of the projector can allow for easy replacement of the lamp. Another heat sink can be positioned near the transmittance window of the lamp, in order to remove heat from the window sleeve and prolong the lifetime of the window assembly. Methods for forming a heat sink are well known and will not be discussed in detail herein. The heat sink can be made of any appropriate material and of any appropriate design providing sufficient heat removal.

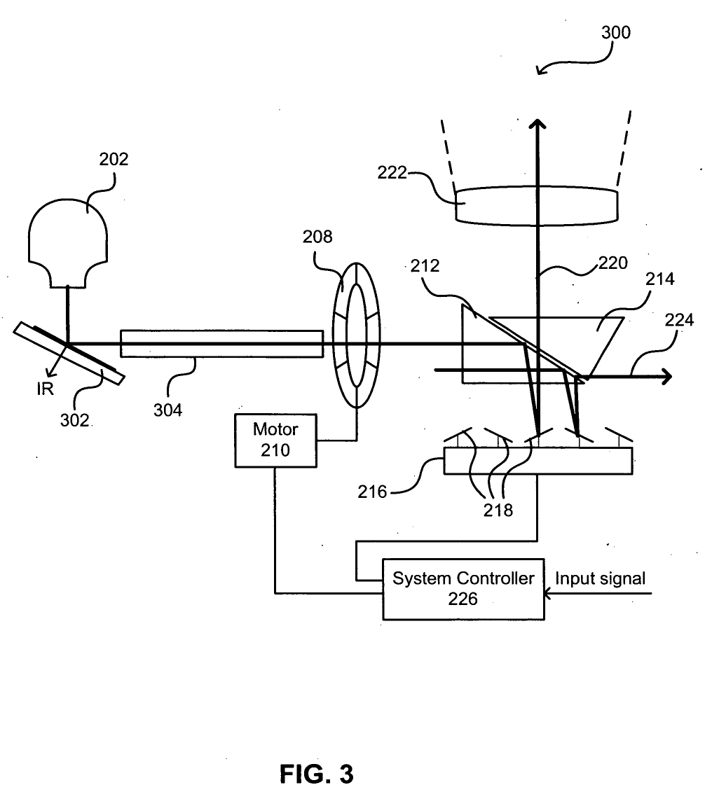

FIG. 3 shows a system 300 in accordance with another embodiment. Reference numbers will be carried over between figures for simplicity where appropriate, but are not intended to be a limitation on the embodiments discussed herein. In FIG. 3, the beam of white light generated by the xenon arc lamp 202 is incident upon a beam separating mirror 302 prior to entering the integrator rod 304. The beam separating mirror can be any mirror capable of reflecting radiation over at least one band of wavelengths, while transmitting radiation over at least one other band of wavelengths. The beam separating mirror is selected to substantially transmit the infrared and/or ultraviolet portion of the light, thereby removing the unnecessary heat and intensity from the beam. The mirror also directs the visible light into the input end of the integrator rod 304. In this configuration the beam separating mirror acts as what is referred to as a “cold mirror,” reflecting visible light and transmitting infrared (IR) radiation. It should be understood that an alternative configuration could be used wherein the infrared (IR) radiation is reflected by the beam separating mirror and the visible light is transmitted. The transmitted infrared light in this embodiment, which is the unwanted portion of the spectrum, can later be captured by what is typically known in the art as a beam dump. The beam separating mirror can be any appropriate mirror, such as may include an appropriately coated dichroic mirror placed on a substrate such as fused silica, glass, or any of a number of other optical materials. The substrate can have different thickness values, typically on the order of a few millimeters. The mirror can be designed to reflect any commonly observed wavelengths or bands of wavelengths, such as may be available from a typical xenon lamp.

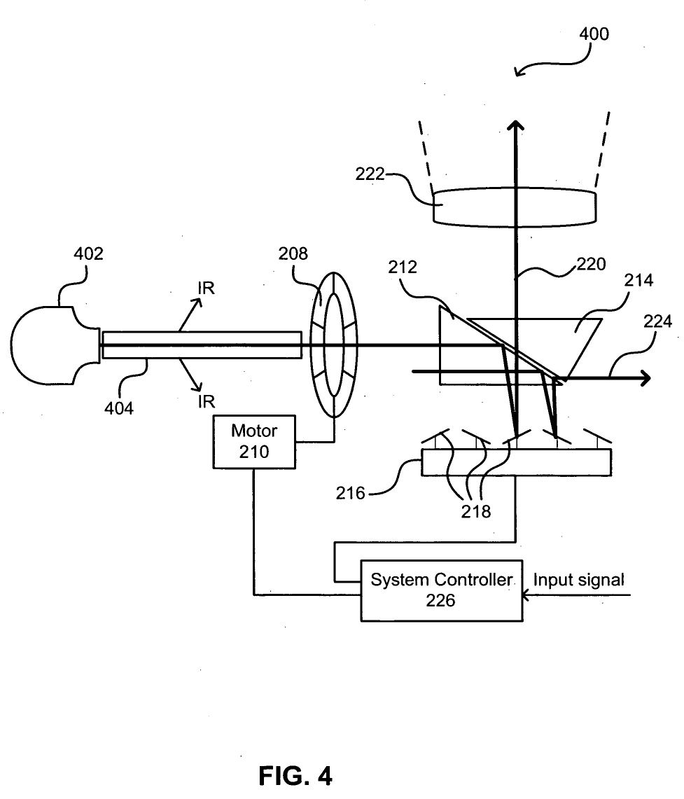

FIG. 4 shows a system 400 in accordance with another embodiment. In this embodiment, a light pipe 404 (a hollow light tunnel in this example) is used that has at least one dichroic coating on the interior and/or the exterior circumference of the tunnel. The light tunnel can be a cylindrical tunnel, or can be an elongated rectangular or rectangular/pyramidal tunnel formed from a plurality of mirrors, glass plates, or other such elements having at least one dichroic coating thereon. A dichroic coating can be selected that allows infrared and/or ultraviolet light incident upon the interior surface(s) of the light tunnel, such as due to internal reflection, to be transmitted through the walls of the light tunnel, while reflecting visible light. This allows any unnecessary heat and intensity due to the infrared and/or ultraviolet radiation to be removed from the beam, while eliminating the need for a beam separating mirror or other optical element. Reducing the heat in this way can do away with the need for a hot mirror and mount, which can reduce the dimensions and cost of the system. Reducing the heat in this way also can do away with the need for active cooling, such as through use of a fan and/or heat sink.

The light tunnel can be positioned in close proximity to the xenon arc lamp 402, and can even be integrated with, brought into contact with, or attached to the lamp in order to improve the intensity of the beam exiting the end of the light tunnel. As shown, the lamp 402 can be oriented horizontally or can be located vertically, and can use any necessary reflecting and/or focusing optical elements to direct the light beam into an input end of the light tunnel. The light tunnel can be any appropriate light tunnel, such as can be made from commonly used optical substrates and dichroic coatings, with thicknesses and materials as described elsewhere herein. The light tunnel can have dimensions in cross-section on the order of a few millimeters square, appropriately chosen for the micro-display size(s). The light tunnel can be designed with or without a taper in the cross-sectional dimensions from one end to the other. The length of the tunnel can be selected to obtain desired amounts of light integration and IR/UV mitigation.

In an alternate embodiment, a solid integrator rod can be used in place of the light tunnel 404 of FIG. 4. In order to allow for transmission of IR and/or UV radiation from the rod along substantially the entire length of the rod, the rod can have a grating (or series of gratings) formed on the outer surface(s) thereof. The integrator rod can be any appropriate material as discussed above, such as fused silica, glass, plastic, or quartz, and can have an elongated cylindrical, rectangular, or pyramidal shape, for example, with dimensions in one embodiment on the order of 10s of millimeters or less in cross-section by 10s of centimeters in length. The grating(s) can be formed on the surface(s) of the integrator rod using any appropriate technique, such as etching. The period(s) of the grating(s) can be selected to substantially reflect visible light, while substantially transmitting IR and/or UV radiation. The gratings also can be selected to reflect only certain bands of radiation, where desired.

Other light pipes can be used which allow a selected band of radiation, such as visible light, to be propagated down the light pipe while at least one other band, such as IR and/or UV radiation, is deflected, transmitted, or otherwise removed from the beam in the light pipe such that the portion of the beam output from the end of the light pipe is substantially composed of the selected band of radiation.

An advantage to a light tunnel or integrator rod as described with respect to FIG. 4 is that the heat generated by the IR and/or UV radiation is dissipated over the entire length of the optic, which can help to minimize damage concerns and can act as a filter to provide further control over color performance. This can be advantageous and more effective than attempting to concentrate and remove the heat at some point in the optical train as in existing systems. Shielding, such as an aluminum plate, or a beam dump as described above can be used to prevent the IR and/or UV radiation from passing out of the light system or being reflected back into the light system. Any of a number of reflective and/or absorptive elements can be used to prevent transmission of this undesired radiation.

Using a light tunnel or integrator rod as the primary point of IR/UV removal can have applications beyond projection. The ability to remove harmful radiation and/or associated heat can have application in technologies such as medical devices and industrial devices, such as fluoroscopes and microscopes. In certain medical applications that utilize a fiber bundle to transmit radiation from an appropriate light source, such as a xenon arc lamp, the end of the fiber bundle can get undesirably hot. By removing the IR/UV and associated heat upstream, the buildup of heat transferred to the patient can be substantially reduced and/or eliminated. Many applications can utilize a light source, illumination system, or illumination source with an integrator or light tunnel capable of removing the undesired radiation and/or associated heat. Another advantage to such an approach is that the radiation/heat is removed using elements that are already present in the system. This is advantageous because there is no need for additional elements, which can increase the cost and difficulty in aligning the system, as well as other known issues with adding optical elements to a system.

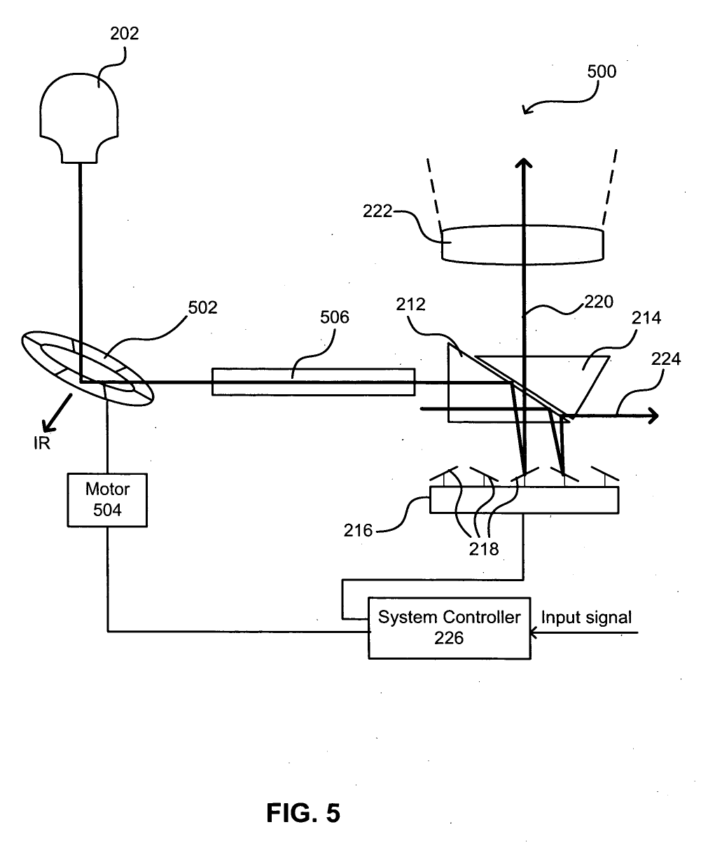

FIG. 5 shows a system 500 in accordance with another embodiment. In this embodiment, the white light beam from the xenon lamp is incident upon a rotating color wheel 502 driven by a wheel motor 504. The filter regions of this color wheel, however, are highly transmissive for infrared and/or ultraviolet light, such as a transmissivity of at least 95%. The filter regions are also highly reflective for visible (and perhaps ultraviolet) light, having a reflectance of at least 95%. This allows the infrared portion of the light beam to be substantially transmitted through the color wheel and out of the beam path. An infrared absorbing element (not shown, but typically positioned a distance away from the color wheel) can be used to absorb the transmitted IR radiation. The reflected visible portion of the beam then can be reflected into an integrator rod 506 to be directed to the rest of the system. In order to obtain the desired transmissivity in the IR spectrum and reflectance in the visible spectrum, the filter regions of the color wheel can be made of common optical materials such as fused silica or glass, and can be coated with dichroic coating materials commonly used in the industry, with typical substrate thicknesses on the order of a few millimeters. It also should be understood that the filter regions can be designed and/or selected to transmit the desired visible light and reflect any unwanted radiation in the beam.

It should be recognized that a number of variations of the above-identified embodiments will be obvious to one of ordinary skill in the art in view of the foregoing description. Accordingly, the invention is not to be limited by those specific embodiments and methods of the present invention shown and described herein. Rather, the scope of the invention is to be defined by the following claims and their equivalents.

What is claimed is:

1. A video projection system, comprising:
a xenon arc lamp for generating a beam of white light;
an integrator rod having an input end that is angled with respect to a central axis of the integrator rod, the angled input end having a dichroic coating thereon such that a desired wavelength component of the beam entering a side of the integrator rod opposite the input end is reflected along the central axis, the dichroic coating further directing an undesired wavelength component of the beam away from the central axis such that substantially none of the unwanted wavelength component propagates along the central axis and exits with the desired component from an output end of the integrator rod;
a digital micromirror device for selectively reflecting portions of the desired component of the beam along one of a projection angle and an non-projection angle; and
a focusing element for collecting the portions of the desired component reflected along the projection angle and focusing those portions as a projected video image.

2. A video projection system according to claim 1, further comprising:
a color filtering device for passing the desired wavelength component through at least one color filter.

3. A video projection system according to claim 2, wherein:
the color filtering device includes a rotatable color wheel for sequentially passing the desired wavelength component received from the output end of the integrator rod through one of a plurality of color filters.

4. A video projection system according to claim 1, wherein:
the undesired wavelength component includes at least one of an infrared component and an ultraviolet component.

5. A video projection system according to claim 1, further comprising:
a prism assembly for directing portions of the beam reflected along the projection angle to the focusing element, and directing portions of the beam reflected along the non-projection angle away from the focusing element.

6. A video projection system according to claim 1, wherein:
the dichroic coating is selected from the group consisting of metallic oxides including at least one of titanium, silicon, and magnesium.

7. A video projection system according to claim 1, further comprising:
a system controller for receiving a video signal and providing an output signal in response thereto, the output signal being received by the digital micromirror device for selectively reflecting portions of the beam.

8. A video projection system according to claim 1 further comprising:
a heat sink for receiving a portion of the xenon arc lamp and transferring heat from a body of the arc lamp.

9. A video projection system, comprising:
a xenon arc lamp having a cathode and an anode for generating a beam of white light;
a mirror element positioned to reflect a desired component of the beam and transmit an undesired component of the beam, whereby substantially none of the undesired wavelength component is reflected with the desired component;
a light pipe for receiving the desired component of the beam at an input end and transmitting the desired component from an output end;
a digital micromirror device for selectively reflecting portions of the desired component along one of a projection angle and a non-projection angle; and
a focusing element for collecting the portions reflected along the projection angle and focusing those portions as a projected video image.

10. A video projection system according to claim 9, further comprising:
a color filtering device for passing the desired component of the beam through at least one color filter.

11. A video projection system according to claim 10, wherein:
the color filtering device includes a rotatable color wheel for sequentially passing the desired component received from the output end of the light pipe through one of a plurality of color filters.

12. A video projection system according to claim 9, wherein:
the mirror element is a dichroic mirror allowing for selective wavelength transmission.

13. A video projection system according to claim 9, wherein:
the undesired component includes at least one of an infrared component and an ultraviolet component.

14. A video projection system according to claim 9, further comprising:
a prism assembly for directing portions of the beam reflected along the projection angle to the focusing element, and directing portions of the beam reflected along the non-projection angle away from the focusing element.

15. A video projection system according to claim 9, further comprising:
a system controller for receiving a video signal and providing an output signal in response thereto, the output signal being received by the digital micromirror device for selectively reflecting portions of the beam.

16. A video projection system according to claim 9, further comprising:
a heat sink for receiving a portion of the xenon arc lamp and transferring heat from a body of the arc lamp.

17. A video projection system, comprising:
a xenon arc lamp having a cathode and an anode for generating a beam of white light;
a light pipe for receiving the beam at an input end, the light pipe operable to propagate a desired wavelength component of the beam along the light pipe and to direct an undesired wavelength component of the beam out of a side of the light pipe, whereby substantially only the desired wavelength component is transmitted from an output end of the light pipe;
a digital micromirror device for selectively reflecting portions of the desired wavelength component along one of a projection angle and a non-projection angle; and
a focusing element for collecting the portions of the desired wavelength component reflected along the projection angle and focusing those portions as a projected video image.

18. A video projection system according to claim 17, wherein:
the light pipe is selected from the group consisting of a solid integrator rod with a dichroic coating on at least one surface, a hollow light tunnel with a dichroic coating on at least one surface, and a solid integrator rod with a grating on at least one surface.

19. A video projection system according to claim 17, further comprising:
a color filtering device for passing the desired wavelength component through at least one color filter.

20. A video projection system according to claim 19, wherein:
the color filtering device includes a rotatable color wheel for sequentially passing the desired wavelength component received from the output end of the light pipe through one of a plurality of color filters.

21. A video projection system, comprising:
a xenon arc lamp having a cathode and an anode for generating a beam of white light;
a rotatable color wheel for sequentially passing the beam through one of a plurality of color filters, the plurality of color filters being transmissive to a first set of wavelengths and reflective to a second set of wavelengths, whereby an undesired wavelength component of the beam is transmitted through the color wheel and a desired wavelength component is reflected by the color wheel;
a digital micromirror device for selectively reflecting portions of the desired wavelength component received from the color wheel along one of a projection angle and an non-projection angle; and
a focusing element for collecting the portions of the desired wavelength component reflected along the projection angle and focusing those portions as a projected video image.

22. A video projection system according to claim 21, wherein:
the undesired wavelength includes at least one of an infrared component and an ultraviolet component.

23. A video projection system according to claim 21, further comprising:
a prism assembly for directing the portions reflected along the projection angle to the focusing element, and directing portions of the beam reflected along the non-projection angle away from the focusing element.

24. A video projection system according to claim 21, wherein:
the color filters of the color wheel each include a substrate having a dichroic coating thereon.

25. A video projection system according to claim 21, further comprising:
a system controller for receiving a video signal and providing an output signal in response thereto, the output signal being received by the digital micromirror device for selectively reflecting portions of the beam.

26. A video projection system according to claim 21, further comprising:
an integrator rod for receiving the desired wavelength component of the beam at an input end and transmitting the desired wavelength component at an output end.

27. An illumination system, comprising:
a light source operable to generate a beam of white light; and
a light pipe for receiving the beam at an input end, the light pipe operable to propagate a desired wavelength component of the beam along the light pipe and to direct an undesired wavelength component of the beam out of a side of the light pipe, whereby substantially only the desired wavelength component is transmitted from an output end of the light pipe as an output beam.

28. An illumination system according to claim 27, wherein:
the light pipe has at least one grating positioned on a surface thereof for reflecting the desired wavelength component along the light pipe and directing the undesired wavelength component out of the side of the light pipe.

29. An illumination system according to claim 27, wherein:
the light pipe has a dichroic coating on a surface thereof for reflecting the desired wavelength component along the light pipe and directing the undesired wavelength component out of the side of the light pipe.

30. An illumination system according to claim 27, wherein:
the light source is a xenon arc lamp having a cathode and an anode for generating the beam of white light.

31. An illumination system according to claim 27, wherein:
the undesired component is one of an infrared and an ultraviolet component.

32. An illumination system according to claim 27, wherein:
the light pipe is a solid rod formed of a material selected from the group of fused silica, quartz, glasses and plastics.

33. An illumination system according to claim 27, wherein:
the light pipe is rectangular in cross-section.

34. An illumination system according to claim 27, wherein:
the light pipe tapers in cross-section from the input end to the output end.

35. An illumination system according to claim 37, wherein:
the light tunnel is a hollow tunnel formed of walls of glass or plastic.

36. An illumination system, comprising:
a light source for generating a beam of white light;
a mirror element positioned to reflect a desired wavelength component of the beam and transmit an undesired wavelength component of the beam, whereby substantially none of the undesired wavelength component is reflected with the desired component; and
a light pipe for receiving the desired component of the beam at an input end and transmitting the desired component from an output end as an output beam.

37. An illumination system, comprising:
a light source for generating a beam of white light; and
a light pipe having an input end that is angled with respect to a central axis of the light pipe, the angled input end configured to receive the beam from the light source through a side of the light pipe opposite the input end, such that the angled input end reflects a desired wavelength component of the beam along the central axis and directs an undesired wavelength component of the beam away from the central axis, whereby substantially only the desired wavelength component propagates along the central axis and is transmitted from an output end of the light pipe as an output beam.

38. An illumination system according to claim 37, wherein:
the angled input end includes a dichroic coating selected to reflect the desired wavelength component and transmit the undesired wavelength component.
